(19) United States
(12) Patent Application Publication
(10) Pub. No.: US 2025/0351895 A1
(43) Pub. Date: Nov. 20, 2025

(54) WEARABLE DEVICE FOR FIRE EVACUATION IN BUILDINGS

(71) Applicant: NATIONAL DISASTER MANAGEMENT RESEARCH INSTITUTE, Ulsan (KR)

(72) Inventors: YEON JU KIM, Ulsan (KR); SEUNG HO YANG, Ulsan (KR); JI HYE PARK, Ulsan (KR); EUN BYUL KIM, Ulsan (KR); SENG YONG CHOI, Ulsan (KR); SO SOON PARK, Ulsan (KR); CHEOL KYU LEE, Ulsan (KR)

(21) Appl. No.: 19/287,437

(22) Filed: Jul. 31, 2025

Related U.S. Application Data
(63) Continuation of application No. PCT/KR2023/007152, filed on May 25, 2023.

(30) Foreign Application Priority Data
Apr. 11, 2023 (KR) 10-2023-0047223

(51) Int. Cl. A41D 1/00; A62B 3/00; A62B 5/00; G01C 21/20

(52) U.S. Cl. CPC A41D 1/002; A62B 3/00; A62B 5/00; G01C 21/206

(57) ABSTRACT

A wearable device for fire evacuation in a building includes a wearing part provided for a user to wear; a communication unit configured to be able to communicate with a disaster management device; an output unit provided in the wearing part to be able to output evacuation guidance information; and a control unit configured to determine an evacuation route corresponding to a position of the user in the building and an expected moving direction of the user on the basis of communication with the disaster management device through the communication unit, and when it is determined that the expected moving direction of the user does not follows the evacuation route, control the output unit to output the evacuation guidance information indicating a corrected moving direction.

### TECHNICAL FIELD

The present disclosure relates to a wearable device provided for a user to wear for the purpose of emergency evacuation in occurrence of a fire in a building, and more particularly, to a wearable device which enables a user wearing the wearable device to move along a normal evacuation route.

### BACKGROUND ART

When emergency situations such as various kinds of disasters and calamities occur, damage of people and property occurs. It is most important to prevent in advance occurrence of such emergency situations. However, once an emergency situation occurs, it is most important to quickly evacuate disaster areas and protect people. A method of protecting people has two aspects. One is to guide people in a disaster area to a safe place when the people can move for themselves, and the other is to quickly and efficiently rescue people in a wide disaster area with limited rescuers when the people are scattered at several places.

For example, when a fire occurs indoors such as a building, a fire site is dark because the supply of electricity to lamps in the building is interrupted due to the fire, and is filled with smoke generated due to combustion of interior materials in the building. In addition, noise of a fire alarm, outcries of evacuating people, blasts due to heating and expansion, and the like are mixed together at the fire site. In such a state, it is difficult for a person at the fire site to calmly understand a current situation, and it is not easy for the person to look for and move to a safe area. The person at the fire site may not acquaint details in the building and may have difficulty in acquainting the details because of the fire and smoke. Therefore, a more intuitive method is required, which enables such people to move to a safe place.

Meanwhile, from the point of view of a rescue team who tries to enter into a fire site from the outside and rescue people, the rescue team has difficulty in rescuing all people at the fire site due to limited rescuers and limited rescue time. Therefore, in terms of rescuing valuable people as many as possible and as quickly as possible, a method of determining which rescue team is to be first sent and to which position the rescue team is to be sent is required.

### SUMMARY

### Technical Problem

The present disclosure is designed to solve the above-described problems, and therefore the present disclosure is directed to providing an intuitive method of enabling people at a fire site in occurrence of a fire in a building to evacuate to a safe place.

### Technical Solution

To achieve the above-described objective, a fire disaster rescue system using a wearable device for fire evacuation in a building according to an embodiment of the present disclosure includes a plurality of wearable devices provided for a plurality of users in the building to wear, respectively; and a disaster management device configured to communicate with the plurality of wearable device, wherein each of the wearable devices may include a wearing part provided for the user to wear; a communication unit configured to be able to communicate with the disaster management device; an output unit provided in the wearing part to be able to output evacuation guidance information; a sensing unit configured to sense an expected moving direction in which a front of the user faces; and a control unit configured to determine an evacuation route corresponding to a position of the user in the building on the basis of communication with the disaster management device through the communication unit, and when it is determined that the expected moving direction sensed by the sensing unit is out of a predetermined angle range having the evacuation route as a center, control the output unit to output the evacuation guidance information indicating a corrected moving direction.

In an embodiment, the wearing part may be worn on an upper body of the user, the sensing unit may include at least one of an inertial measurement unit, an optical sensor, a magnetometer, a gyroscope, and an accelerometer, which are capable of measuring a turning angle of the upper body, and the control unit may determine whether or not the turning angle is out of the angle range when the upper body turns in a state in which the upper body moves along the evacuation route.

In an embodiment, the sensing unit may sense a direction change according to turning of the upper body of the user, and when a direction change from an initial direction along the evacuation route is sensed by the sensing unit, the control unit may determine the expected moving direction on the basis of a degree of the direction change.

In an embodiment, the output unit may include a left vibration unit and a right vibration unit, which are provided to be able to vibrate and are respectively disposed at a left side and a right side of the wearing part.

The control unit may vibrate the right vibration unit when it is determined that the front of the upper body is turned leftward with respect to the evacuation route, and vibrate the left vibration unit when it is determined that the front of the upper body is turned rightward with respect to the evacuation route.

In an embodiment, the disaster management device may determine a rescue priority order of each of the plurality of users on the basis of state information of the users, which are acquired from the plurality of wearable devices, determine, as an emergency rescue target person, at least one of the plurality of users, of which the rescue priority order is high, and provide rescue information including a position of the determined emergency rescue target person and the state information to a rescuer having a rescue role suitable for a state of the emergency rescue target person among a plurality of rescuers having different rescue roles.

In an embodiment, the disaster management device may determine a rescue priority order of each of the plurality of users on the basis of state information of the users, which are acquired from the plurality of wearable devices, determine, as an emergency rescue target person, at least one of the plurality of users, of which the rescue priority order is high, and provide rescue information including a position of the determined emergency rescue target person and the state information; the state information may further include information on whether each of the users respectively wearing the wearable devices is moving or stopping; and the disaster management device may adjust the determined rescue priority order on the basis of whether each of the users is moving or stopping.

### Advantageous Effects

According to the present disclosure, it is possible to guide people at a fire site in occurrence of a fire to quickly and easily evacuate to a safe place even in a state in which the people are confused and embarrassed.

### BRIEF DESCRIPTION OF DRAWINGS

FIG. 1 is an exemplary diagram of a fire disaster rescue system according to an embodiment of the present disclosure.

FIG. 2 is an exemplary diagram illustrating a method in which a wearable device determines whether or not an expected moving direction of a user follows an evacuation route according to an embodiment of the present disclosure.

FIG. 3 is an exemplary diagram illustrating a situation in which victims in a disaster zone, detected by a disaster management device, are scattered and structural information reflecting the situation according to an embodiment of the present disclosure.

FIG. 4 is an exemplary diagram illustrating a case where the disaster management device transmits different structural information respectively to a plurality of mobile terminals according to an embodiment of the present disclosure.

### DETAILED DESCRIPTIONS OF EXEMPLARY EMBODIMENTS

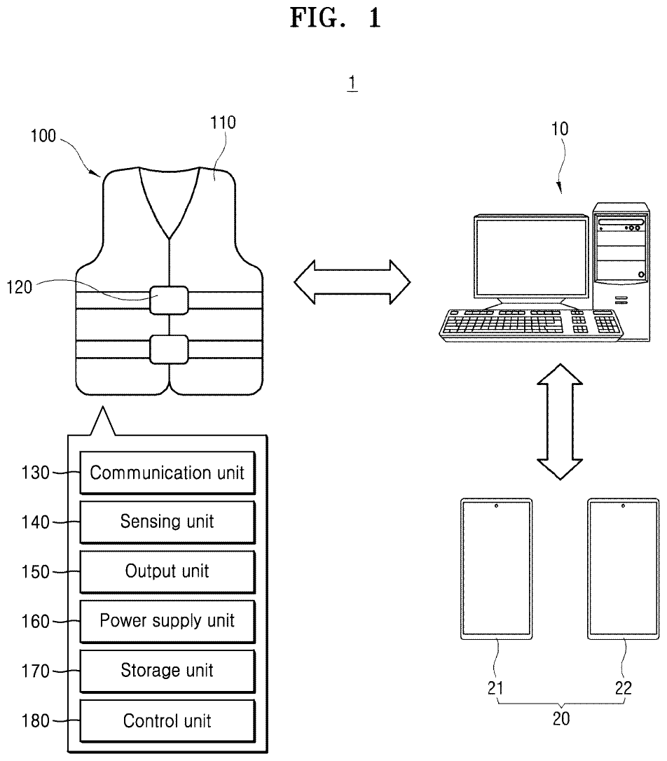

FIG. 1 is an exemplary diagram of a fire disaster rescue system according to an embodiment of the present disclosure.

As shown in FIG. 1, the fire disaster rescue system 1 according to this embodiment includes a wearable device 100 provided for a user in a predetermined disaster zone (e.g., in a building) to wear, a disaster management device 10 which is disposed at a position (e.g., a disaster management center outside the building) spaced apart from the disaster zone and wirelessly communicates with the wearable device 100, and a mobile terminal 20 which wirelessly communicates with the disaster management device 10.

The wearable device 100 is equipped in plurality in the disaster zone such that users in the disaster zone can wear the plurality of wearable devices in time of emergency. The shape of the wearable device 100 is not limited. For example, various examples including a vest put on an upper body, a gas mask put on a head, bracelets respectively put on two wrists, and the like may be implemented. In this embodiment, a case where the wearable device 100 has a vest shape is described. The wearable device 100 includes a wearing part 110, a buckle 120, a communication unit 130, a sensing unit 140, an output unit 150, a power supply unit 160, a storage unit 170, and a control unit 180.

The wearing part 110 is provided for a user to be able to easily wear in a state in which the user has already wear clothes, and has a vest shape put on an upper body of the user. The wearing part 110 is made of a fabric material, and the fabric material have heat-resistance and flame-resistance characteristics because of a characteristic that the wearing part 110 is worn in a fire. The wearing part 110 is coupled to several components constituting the wearable device 100 or accommodates these components.

The buckle 120 is provided at a front of the wearing part 110, and has, for example, a hook structure such that the user wearing the wearing part 110 can easily fasten the buckle 120. The buckle 120 not only prevents the wearing part 110 from being taken off from the user but also serves as a power switch for turning on the wearable device 100. That is, the wearable device 100 is equipped in a state in which the wearable device 100 is turned off. When the user wears the wearable device 100 and fastens the buckle 120 in time of emergency, the wearable device 100 is turned on. The buckle 120 may be replaced with various types of structures. For example, a structure is also possible in which magnet switches are respectively provided at a front left side and a front right side of the wearing part 110, and the wearable device 100 is turned on when the two magnet switches are coupled to each other by magnetism.

The communication unit 130 include a wireless communication chip which performs wireless communication with the disaster management device 10. For example, various examples including Wi-Fi, Zigbee, and the like may be used as a protocol of the wireless communication. When the wearable device 100 is turned on, the communication unit 130 establishes a communication route such that communication with the disaster management device 10 is possible.

The sensing unit 140 senses various states of the user. Since the sensing unit 140 includes a sensor corresponding to a characteristic to be sensed, the sensing unit 140 may be provided as, for example, a group of plurality of sensors which respectively sense a plurality of characteristics. According to this embodiment, the sensing unit 140 is provided at a front (e.g., chest) of the user to sense a current position of the user wearing the wearing part 110 and a direction in which the front of the user faces.

Various design examples may be applied to the structure of the sensing unit 140, and are, for example, as follows. The sensing unit 140 may include an inertial measurement unit (IMU). The IMU is a sensor which measures a movement and a direction of a device by combining an accelerometer, a gyroscope, and a magnetometer sometimes. Alternatively, the sensing unit 140 may include a global navigation satellite system (GNSS) sensor, such as a GPS, a GLONASS or Galileo, which can determine a position and a direction of the user on the basis of signals from a satellite, such as a GNSS. Alternatively, the sensing unit 140 may include an optical sensor which traces an environment of the user, using a camera or a depth sensor, and senses a direction of the user on the basis of a receiving angle of light received from a predetermined external device. Alternatively, the sensing unit 140 may include a magnetometer which is a sensor capable of measuring an intensity and a direction of Earth's magnetic field. The magnetometer may be used to determine a direction of a device on the basis of magnetic north, and therefore, may determine a direction in which a person faces. Alternatively, the sensing unit 140 may include a digital compass which is a kind of magnetometer particularly designed to measure a magnetic north direction. Alternatively, the sensing unit 140 may include a gyroscope which is a sensor capable of sensing a direction and a change in angular velocity. The gyroscope traces a movement of a person and a direction change, thereby determining a direction in which the person faces. Alternatively, the sensing unit 140 may include an accelerometer which is a sensor capable of sensing an acceleration and a change in movement. The accelerometer measures a movement of a person and a change in velocity, thereby determining a direction in which the person faces.

In an embodiment, the sensing unit 140 can further include a gas sensor for sensing ambient air quality at predetermined time intervals or continuously to determine if the toxicity of smoke is increasing. Additionally, the sensing unit 140 is disposed at a plurality of locations on the wearing part 110 to calculate the user's upper body rotation and bending angles, and in particular, senses the degree to which the user is bending at the waist. The sensing unit 140 can include a gas sensor that measures the concentration of harmful gases that can occur during a fire, such as toxic gases, carbon monoxide, and carbon dioxide. Furthermore, a plurality of angle sensors or inertial sensors for precisely measuring the user's upper body bending angle can be distributed at a plurality of locations on the wearing part 110, for example, at the waist, back, and shoulder areas.

The output unit 150 outputs preset evacuation guidance information corresponding to a state of the user, which is sensed by the sensing unit 140. For example, when an evacuation route from a current position of the user in the disaster zone from a target point which is a safe place is set, the evacuation guidance information indicates a corrected moving direction in a case where it is determined that an expected moving direction expected that the user will move does not follow the evacuation route. The expected moving direction is a direction in which the front of the upper body of the user faces at a current posture of the user.

In an embodiment, the output unit 150 can further include a guide part disposed along the back or abdomen of the wearing part 110 to guide the user to bend at the waist. This guide part is operated by a driving part (composed of one or more motors) and operates according to commands from the control unit. The guide part can be composed of a plurality of members that rotate based on one or more links. For example, it can consist of two rigid members longitudinally disposed on the back portion of the wearing part 110, including a hinge or rotatable link at a point corresponding to the user's waist. These two members, under the control of the driving part, fold or rotate by reducing the angle between them, thereby guiding the user to bend at the waist by pushing or pulling the user's waist portion forward. This corresponds to any mechanical configuration disposed on the front or back of the wearable vest that guides the user to assume a safe posture.

The control unit 180 can control the operation of the guide part to guide the user to bend further at the waist when the concentration of toxic gas is high based on gas sensor information from the sensing unit 140, that is, when it is determined that toxic gas is located in the upper part. In this case, the guide part can operate along with or independently of an audible alarm such as ‘Bend further at your waist’ to induce the user's waist bending.

The output unit 150 outputs the evacuation guidance information in a manner that stimulates at least one of five senses of the user. For example, at least one mode of sight, hearing, and touch may be applied to the output unit 150. Although any modes are possible, a touch mode may be relatively advantageous in consideration that flames and noises excessively occur in a fire disaster zone. A specific method in which the output unit 150 outputs the evacuation guidance information will be described later.

The power supply unit 160 includes a battery. When the wearable device 100 is turned on, the power supply unit 160 supplies power for operation to each component.

The storage unit 170 stores preset information necessary for operations of the control unit 180. The storage unit 170 includes, for example, a flash memory, a read-only memory (ROM), and the like.

The control unit 180 is a component which performs calculations to control operations of the wearable device 100, and is implemented as a hardware circuit including a CPU, a microprocessor, a microcontroller, a chipset, and the like, mounted on a printed circuit board. The control unit 180 determines an expected moving direction of the user on the basis of a sensing result of the sensing unit 140, and when the expected moving direction does not follow the evacuation route, controls the output unit 150 to output evacuation guidance information indicating a corrected moving direction (i.e., an evacuation direction following the evacuation route).

The disaster management device 10 includes a computer or an electronic device equal thereto. The disaster management device 10 includes a configuration equal to an ordinary electronic device, e.g., a configuration including a display, a wireless communication unit, a user input unit, a storage unit, a control unit, and the like. The disaster management device 10 performs wireless communication with the wearable device 100 and the mobile terminal 20. The disaster management device 10 may store an evacuation route on the basis of a map in the building which is a disaster zone, and may provide information on the evacuation route to the wearable device 100. The wearable device 100 determines whether or not the expected moving direction of the user follows the evacuation route with reference to the information on the evacuation route. Also, the disaster management device 10 may determine a rescue priority order of each of users scattered in the building on the basis of a state of each of the users, and may provide information on the rescue priority orders to the mobile terminal 20.

A rescuer or a rescue team, which enters into the disaster zone and performs rescue, carries the mobile terminal 20. A plurality of rescuers or rescue teams may be sent to a plurality of positions of the disaster zone at a same time, and each mobile terminal 20 is provided to a rescuer or a rescue team, which is sent to each position. In this example, a case where the mobile terminal 20 is provided with two of a first mobile terminal 21 and a second mobile terminal 22 is described. However, this is not limited, and a number of mobile terminals 20 may correspond to a number of rescuers or rescue teams, which are sent to respective positions. The mobile terminal 20 displays information received from the disaster management device 10, to enable a rescuer or a rescue team, which carries the corresponding mobile terminal 20, to realize a position into which the rescuer or the rescue team is to be sent.

The disaster management device 10 according to this embodiment determines a current position of the wearable device 100. For example, the current position of the wearable device 100 may be specified through communication between a beacon device which transmits beacon signals and the wearable device 100 and communication between the disaster management device 10 and the wearable device 100. The wearable device 100 receives, from the disaster management device 10, information an evacuation route (i.e., a route facing a safe place which is a target point) corresponding to the current position.

The wearable device 100 determines an expected moving direction of the user, thereby determining whether or not the expected moving direction is out of a target direction (i.e., whether or not the expected moving direction is a direction which does not follow the evacuation route). When it is determined that the expected moving direction is out of the target direction, the wearable device 100 provides the user with evacuation guidance information guiding the target direction.

Hereinafter, a method in which the wearable device 100 determines whether or not an expected moving direction of a user is out of a target direction, i.e., follows an evacuation route will be described.

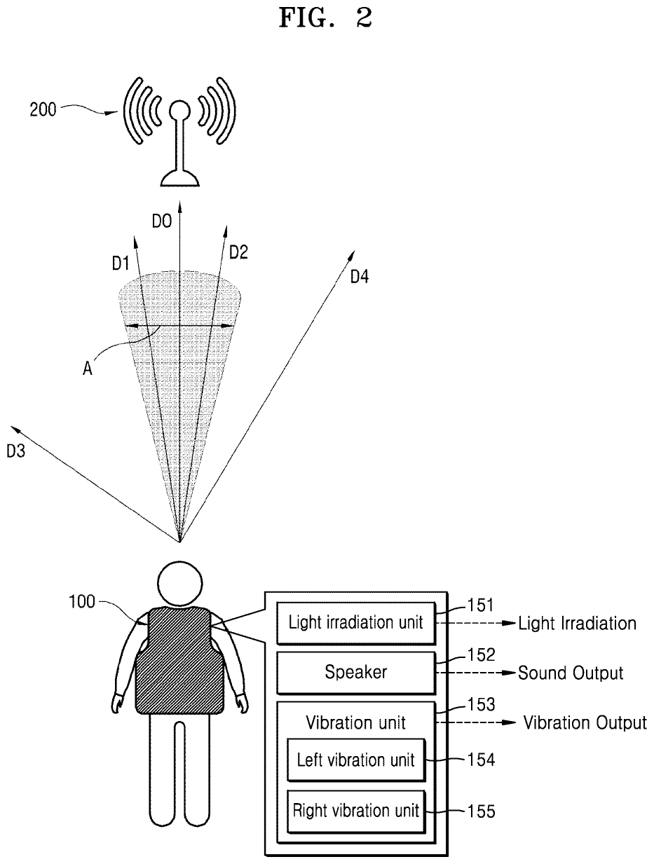

FIG. 2 is an exemplary diagram illustrating a method in which the wearable device determines whether or not an expected moving direction of a user follows an evacuation route according to an embodiment of the present disclosure.

As shown in FIGS. 1 and 2, the wearable device 100 may determine an expected moving direction on the evacuation route provided from the disaster management device 10. However, the above-described determination is not necessarily limited to one performed by the wearable device 100, and the wearable device 100 may receive determination of the disaster management device 10. The expected moving direction may be determined using various methods, and a beacon device 200 which transmits signals with a predetermined standard may be used as an example.

For example, the wearable device 100 receives a signal transmitted from the beacon device 200 and determines an expected moving direction on the basis of a receiving angle of the signal. The signal may be an optical signal or may be a beacon signal. According to the standard of the signal, the sensing unit 140 may sense the signal or the communication unit 130 may receive the signal. For example, when the beacon device 200 exists on the evacuation route and the receiving angle of the signal from the beacon device 200 is within a predetermined angle range, this means that the user take a posture toward an evacuation direction in which the front of the user follows the evacuation route. When the receiving angle is out of the corresponding angle range, this means that the posture of the user does not face the evacuation direction.

Alternatively, the wearable device 100 senses a directional change according to turning of the upper body of the user, and when a directional change from an initial direction is sensed by the sensing unit 140, may determine an expected moving direction on the basis of a degree of the directional change. For example, it may be considered that the user moves along the evacuation route and then makes a direction change to a direction in which the user does not follows the evacuation route at a certain time. When an angle of the direction change exceeds a threshold value, the wearable device 100 determines that the expected moving direction does not follows the evacuation route.

For example, cases where the direction in which the front of the upper body of the user faces are D1, D2, D3, D4 with respect to an evacuation route DO, respectively, are considered. D1 and D3 are cases where the direction in which the front of the upper body of the user faces is changed leftward from the evacuation route DO, and D2 and D4 are cases where the direction in which the front of the upper body of the user faces is changed rightward from the evacuation route DO. A predetermined angle range A having the evacuation route DO as a center may be set. When the direction in which the front of the upper body of the user faces is within the angle range A, it is determined that the expected moving direction follows the evacuation route. When the direction in which the front of the upper body of the user faces is out of the angle range A, it is determined that the expected moving direction does not follow the evacuation route. That is, D1 and D2 are cases where the expected moving direction follows the evacuation route, and D3 and D4 are cases where the expected moving direction does not follow the evacuation route.

Under such determination, the control unit 180 controls the output unit 150 to output evacuation guidance information. A method of outputting the evacuation guidance information may be provided as several methods according to the structure of the output unit 150 and the control method of the control unit 180.

In an example, the output unit 150 includes a light irradiation unit 151 which includes a light source such as an LED and irradiates light into the front of the user such that the user can keep an eye thereon. The control unit 180 controls the light irradiation unit 151 such that a method of irradiating light (an irradiation pattern, a color of the light, or the like) is changed according to a situation. For example, the control unit 180 controls the light irradiation unit 151 to irradiate light with a predetermined first pattern when the expected moving direction follows the evacuation route, and controls the light irradiation unit 151 to irradiate light with a second pattern different from the first pattern when the expected moving direction does not follow the evacuation route. Alternatively, the control unit 180 controls the light irradiation unit 151 to irradiate blue light when the expected moving direction follows the evacuation route, and controls the light irradiation unit 151 to irradiate red light when the expected moving direction does not follow the evacuation route.

In another example, the output unit 150 includes a speaker 152 which outputs sounds. The control unit 180 controls the speaker 152 such that a method of outputting a sound (an output pattern of the sound, a volume of the sound, an output cycle of a beep sound, or the like) is changed according to a situation. For example, the control unit 180 controls the speaker 152 to output a sound with a first pattern when the expected moving direction follows the evacuation route, and controls the speaker 152 to output a sound with a second pattern different from the first pattern when the expected moving direction does not follow the evacuation route. Alternatively, the control unit 180 controls the speaker 152 to output a sound with a relatively low volume when the expected moving direction follows the evacuation route, and controls the speaker 152 to output a sound with a relatively high volume when the expected moving direction does not follow the evacuation route. Alternatively, the control unit 180 controls the speaker 152 to output a beep sound with a long output cycle when the expected moving direction follows the evacuation route, and controls the speaker 152 to output a beep sound with a short output cycle when the expected moving direction does not follow the evacuation route.

In another example, the output unit 150 includes a vibration unit 153 including a vibration element which converts electrical energy into vibration. The control unit 180 controls the vibration unit 153 such that a vibration method (a vibration pattern, a vibration intensity, a vibration cycle, or the like) is changed according to a situation. For example, the control unit 180 controls the vibration unit 153 to vibrate with a first pattern when the expected moving direction follows the evacuation route, and controls the vibration unit 153 to vibrate with a second pattern different from the first pattern when the expected moving direction does not follow the evacuation route. Alternatively, the control unit 180 controls the vibration unit 153 to vibrate with a relatively low intensity when the expected moving direction follows the evacuation route, and controls the vibration unit 153 to vibrate with a relatively high intensity when the expected moving direction does not follow the evacuation route. Alternatively, the control unit 180 controls the vibration unit 153 to vibrate with a long cycle when the expected moving direction follows the evacuation route, and controls the vibration unit 153 to vibrate with a short cycle when the expected moving direction does not follow the evacuation route.

In another example, a method in which the output unit 150 more intuitively provide a corrected moving direction to the user is possible. The vibration unit 153 includes a left vibration unit 154 provided to transfer vibration to a left half body of the user and a right vibration unit 155 provided to transfer vibration to a right half body of the user. The control unit 180 controls the right vibration unit 155 to vibrate corresponding to that it is determined that, like D3, the front of the upper body of the user is turned leftward with respect to the evacuation route DO. On the other hand, the control unit 180 controls the left vibration unit 154 to vibrate corresponding to that it is determined that, like D4, the front of the upper body of the user is turned rightward with respect to the evacuation route DO. When the right vibration unit 155 vibrates in a state in which the front of the upper body of the user is turned leftward with respect to the evacuation route DO, the user will unconsciously turn the upper body rightward, and thus the user can intuitively follow the evacuation route. That is, the wearable device 100 according to this embodiment does not guide the evacuation route simply on the basis of a current position but the posture of the user intuitively guides the evacuation direction along the evacuation route, so that the posture of the user is quickly corrected before the user is put in danger, thereby minimizing damage.

Meanwhile, when several users (hereinafter, referred to as victims) respectively wearing wearable devices 100 are scattered at a plurality of positions in a disaster zone, the disaster management device 10 may provide information on rescue priority orders to a rescue team having the mobile terminal 20. Hereinafter, such an embodiment will be described.

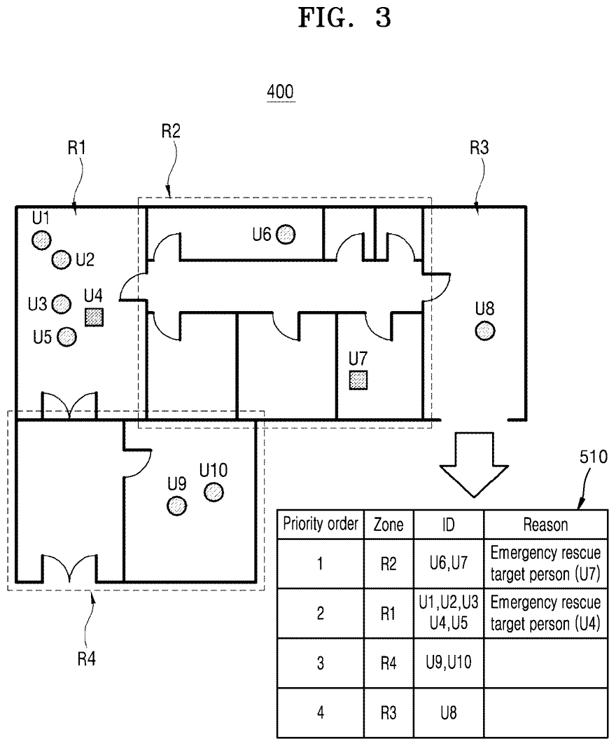

FIG. 3 is an exemplary diagram illustrating a situation in which victims in a disaster zone, detected by the disaster management device, are scattered and structural information reflecting the situation according to an embodiment of the present disclosure.

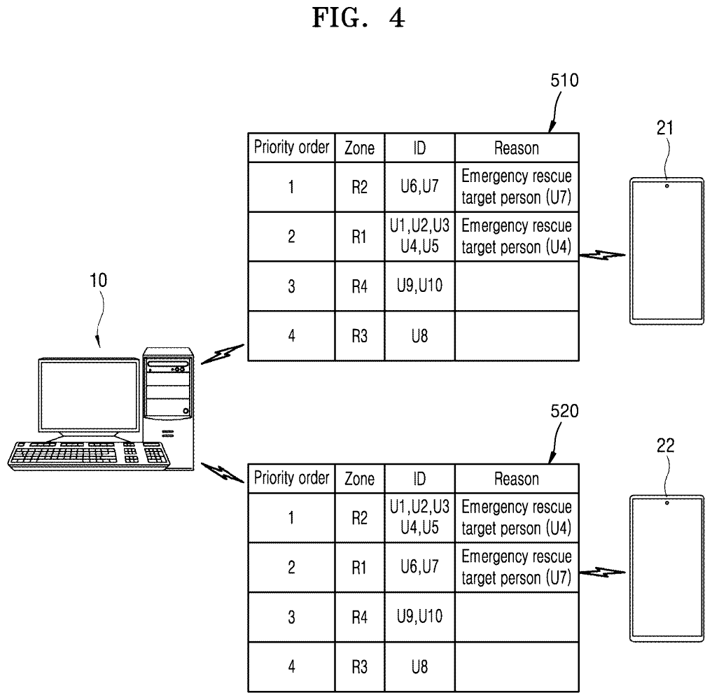

As shown in FIGS. 1 and 3, the disaster management device 10 may determine current positions of a plurality of users respectively wearing a plurality of wearable devices 100 by communicating with the plurality of wearable devices 100. The disaster management device 10 has a map of a disaster zone 400, and determines positions of the users in a plurality of division zones divided in the disaster zone 400. As shown in FIG. 4, according to an example, the disaster zone 400 is divided into four division zones of R1, R2, R3 and R4, users U1, U2, U3, U4 and U5 are currently located in a division zone R1, U6 and U7 are currently located in a division zone R2, a user U8 is currently located in a division zone R3, and users U9 and U10 are currently located in a division zone R4.

Also, the disaster management device 10 may communicate with each wearable device 100, thereby acquiring state information of a user wearing the corresponding wearable device 100. The state information is, for example, information on vital signs of the user (e.g., breath, temperature, impulse, and the like), and may include various reference information capable of determining a current health condition of the user, in addition to the vital signs.

The disaster management device 10 determines rescue priority orders of the plurality of users on the basis of state information of the plurality of users, which are respectively acquired from the plurality of wearable devices 100. The rescue priority orders mean references with which, when a rescue team is sent to the disaster zone 400 from the outside to rescue the users in the disaster zone 400, the rescue team is to be first sent. In this embodiments, since it is set for a rescue team to be sent to each division zone, the rescue team is preferentially sent to a division zone in which a user having a high rescue priority order is located. Since the number of rescuers of the rescue team is limited, for the purpose of efficient rescue, it is necessary to define orders of division zones to which the rescue team is to be sent by determining the rescue priority orders.

For example, the disaster management device 10 identifies, as at least one emergency rescue target person having a high rescue priority order, users, e.g., U4 and U7, which have high degrees of urgency according to vital signs, among the plurality of users. A degree of urgency according to vital signs is a reference with which a user is determined as a person to be urgently rescued according to vital signs thereof. For example, when a value of a specific vital sign is out of a threshold value of a pre-defined normal range, it may be determined that the degree of urgency according to the vital sign is high. The disaster management device 10 identifies that a rescue priority order of U7 having a higher degree of urgency is higher than a rescue priority order of U4 among U4 and U7 having the high degrees of urgency according to the vital signs.

The disaster management device 10 determines the division zone R2 in which U7 having the highest degree of urgency is located as the highest rescue priority order, and determines the division zone R1 in which U4 having the next highest degree of urgency is located as the next highest rescue priority order. With respect to the division zones R3 and R4 in which the other users are located, the disaster management device 10 sequentially determines rescue priority orders according to a separate reference (e.g., a number of users in the division zones, a degree to which users easily evacuate to a safe place from the division zones, or the like).

The disaster management device 10 displays a UI including rescue information 510 with contents described above on a display or transmits the UI to the mobile terminal 20 that the rescue team carries. The rescue team can easily recognize, through the rescue information 510 displayed on the mobile terminal, that a division zone to which the rescue team is to be most preferentially sent is R2 in which the emergency rescue target person U7 is located and a division zone to which rescue team is to be next most preferentially sent is R1 in which the emergency recue person U4 is located.

Meanwhile, when a plurality of rescue teams is to be simultaneously sent to respective division zones of the disaster zone 400, all the rescue teams are not sent to a same division zone, but sent to respect division zones, which may be more efficient in rescue. In such a case, the disaster management device 10 may transmit the structure information 510 with different contents to the mobile terminals 20 of respective rescue teams. Hereinafter, such an embodiment will be described.

FIG. 4 is an exemplary diagram illustrating a case where the disaster management device transmits different structural information respectively to a plurality of mobile terminals according to an embodiment of the present disclosure.

As shown in FIGS. 1, 3, and 4, a plurality of mobile terminals 20 include a first mobile terminal 21 which a first rescue team carries and a second mobile terminal 22 which a second rescue team carries. For example, the disaster management device 10 transmits first rescue information 510 to the first mobile terminal 21. Contents of the first rescue information 510 are the same as the contents of the rescue information 510 described above in FIG. 3.

Meanwhile, the disaster management device 10 transmits second rescue information 520 to the second mobile terminal 22. The first rescue information transmitted to the first mobile terminal 21 specifies, as a first rescue priority order, the division zone R2 in which the emergency rescue target person U7 is located. Therefore, since the first rescue team is to check the first rescue information 510 and be sent to the division zone R2, it is unnecessary for the second rescue team carrying the second mobile terminal 22 to be sent to the same division zone R2. It is efficient for the second rescue team to be sent to the division zone R1 having the highest rescue priority order among the other division zones except the division zone R2.

Therefore, unlike the first rescue information 510, in the second rescue information 520, the rescue priority order of the division zone R1 in which the emergency rescue target person U4 is located is specified higher than the rescue priority order of the division zone R2. Accordingly, the second rescue team may check the second rescue information 520 and be sent to the division zone R1.

Alternatively, rescue teams are sent respectively to a plurality of division zones in which emergency rescue target people are located at a time when the rescue teams are initially sent, and therefore, each rescue team may recognize only any one of the plurality of division zones. In this case, the first rescue information 510 may be provided such that the division zone R1 in which the emergency rescue target person U4 is located is deleted from the rescue priority orders, and the second rescue information 520 may be provided such that the division zone R2 in which the emergency rescue target person U7 is located is deleted from the rescue priority orders.

In an embodiment, the plurality of rescue teams have different rescue sequences or roles, and the disaster management device 10 may transmit the rescue information 510 including state information of a user to be rescued to the mobile terminal of a rescue team having a rescue sequence or role suitable for the corresponding user among the plurality of rescue teams. For example, it is assumed that while the second rescue team can perform only a fundamental rescue role, the first rescue team can perform not only the fundamental rescue role but also a role including a specific medical treatment, and the like. When it is determined that a current state of a user to be rescue is a state in which a specific medical treatment is urgently required in addition to simple rescue, based on state information of the user, the disaster management device 10 may transmit the rescue information 510 including the state information of the corresponding user to the first mobile terminal 21 of the first rescue team which can perform such a medical treatment. As such, according to a state of a user to be rescued, a rescuer suitable for the state of the user is matched to the user, thereby enabling more effective rescue.

Meanwhile, rescue priority orders in the rescue information 510 may be determined or adjusted according to additional references in addition of vital signs of users. For example, a rescue priority order may be set higher with respect to a division zone as the number of users in the division zone becomes larger, as the distance from the division zone to a safe place becomes longer, as the division zone is more distant from an origin of fire, and as the number of users being currently moving becomes smaller (i.e., as the number of users being currently stopping becomes larger). For example, the disaster management device 10 may specify a rescue priority order of an emergency rescue target person determined on the basis of the vital signs of the users to be highest, and sequentially specify rescue priority orders with respect to the other users according to the above-described additional references.

Meanwhile, the disaster management device 10 may determine an optimum sent position of a specific rescue team corresponding to a specific user wearing the wearable device 100, and allow the wearable device 100 to guide the corresponding user by reflecting the optimum sent position on an evacuation route. The above-described determination may be performed by the wearable device 100 in addition to the disaster management device 10. For example, it is considered that the wearable device 100 performs guidance such that a user moves along an evacuation route toward a predetermined target position. When it is determined that there is a rescue team approaching the corresponding user, and the rescue team is located closer than the target position, the disaster management device 10 changes the evacuation route from the target position to a position at which the rescue team is located, and re-determines an expected moving direction of the user according to the changed evacuation route. Accordingly, the wearable device 100 enables the user to more quickly meet the rescue team.

1. A fire disaster rescue system using a wearable device for fire evacuation in a building, the fire disaster rescue system comprising:
a plurality of wearable devices provided for a plurality of users in the building to wear, respectively; and
a disaster management device configured to communicate with the plurality of wearable device,
wherein each of the wearable devices includes:
a wearing part provided for the user to wear;
a communication unit configured to be able to communicate with the disaster management device;
an output unit provided in the wearing part to be able to output evacuation guidance information;
a sensing unit configured to sense an expected moving direction in which a front of the user faces; and
a control unit configured to:
determine an evacuation route corresponding to a position of the user in the building on the basis of communication with the disaster management device through the communication unit; and
when it is determined that the expected moving direction sensed by the sensing unit is out of a predetermined angle range having the evacuation route as a center, control the output unit to output the evacuation guidance information indicating a corrected moving direction.

2. The fire disaster rescue system according to claim 1,
wherein the wearing part is worn on an upper body of the user,
wherein the sensing unit includes at least one of an inertial measurement unit, an optical sensor, a magnetometer, a gyroscope, and an accelerometer, which are capable of measuring a turning angle of the upper body, and
wherein the control unit determines whether or not the turning angle is out of the angle range when the upper body turns in a state in which the upper body moves along the evacuation route.

3. The fire disaster rescue system according to claim 1,
wherein the sensing unit senses a direction change according to turning of the upper body of the user, and
wherein, when a direction change from an initial direction along the evacuation route is sensed by the sensing unit, the control unit determines the expected moving direction on the basis of a degree of the direction change.

4. The fire disaster rescue system according to claim 2,
wherein the output unit includes a left vibration unit and a right vibration unit, which are provided to be able to vibrate and are respectively disposed at a left side and a right side of the wearing part, and
wherein the control unit:
vibrates the right vibration unit when it is determined that the front of the upper body is turned leftward with respect to the evacuation route; and
vibrates the left vibration unit when it is determined that the front of the upper body is turned rightward with respect to the evacuation route.

5. The fire disaster rescue system according to claim 1,
wherein the disaster management device:
determines a rescue priority order of each of the plurality of users on the basis of state information of the users, which are acquired from the plurality of wearable devices;
determines, as an emergency rescue target person, at least one of the plurality of users, of which the rescue priority order is high; and
provides rescue information including a position of the determined emergency rescue target person and the state information to a rescuer having a rescue role suitable for a state of the emergency rescue target person among a plurality of rescuers having different rescue roles.

6. The fire disaster rescue system according to claim 1,
wherein the disaster management device:
determines a rescue priority order of each of the plurality of users on the basis of state information of the users, which are acquired from the plurality of wearable devices; and
determines, as an emergency rescue target person, at least one of the plurality of users, of which the rescue priority order is high, and provides rescue information including a position of the determined emergency rescue target person and the state information,
wherein the state information further includes information on whether each of the users respectively wearing the wearable devices is moving or stopping, and
wherein the disaster management device adjusts the determined rescue priority order on the basis of whether each of the users is moving or stopping.
